(19) United States
(12) Patent Application Publication
(10) Pub. No.: US 2012/0193370 A1
(43) Pub. Date: Aug. 2, 2012

(54) MOLDED CLOSURE WITH ENHANCED LUBRICANT DISTRIBUTION

(76) Inventors: John Erspamer, Crawfordsville, IN (US); Bob Medsker, Crawfordsville, IN (US)

(21) Appl. No.: 13/260,700

(22) PCT Filed: Mar. 29, 2010
(86) PCT No.: PCT/US10/29023

§ 371 Date: Apr. 18, 2012

Related U.S. Application Data
(60) Provisional application No. 61/211,300, filed on Mar. 27, 2009.

(51) Int. Cl. B65D 41/16; C09D 5/20; B28B 7/38

(52) U.S. Cl. 220/780; 427/133; 427/155

(57) ABSTRACT

An improved molded plastic closure is provided, wherein the closure is formed from polymeric resin material, and exhibits a relatively higher concentration of a lubricant composition on an inside surface thereof, including one or more selected regions of the inside surface, to facilitate application to and removal from an associated container, The present invention contemplates a method of making a molded closure by selective application of a lubricant composition to one or more regions of the inside surface thereof. Two different types of lubricant compositions can be applied at two different regions of the inside surface of the closure, wherein the compositions can be selected for preferred organoleptic and lubrication characteristics.

### TECHNICAL FIELD

The present invention relates generally to molded plastic closures formed from polymeric resin material, and more particularly to a molded plastic closure having relatively higher concentration of lubricant on an inside surface thereof, including one or more selected regions of the inside surface, to facilitate application to and removal from an associated container, while at the same time facilitating closure manufacture, and minimizing lubricant usage.

### BACKGROUND OF THE INVENTION

Use of molded plastic closures, typically formed from polymeric material such as polypropylene or polyethylene, or the like, have found widespread acceptance in the marketplace for use on associated containers, including both carbonated and non-carbonated beverages. Efficient formation of closures of this nature can be effected by compression molding, wherein cooperating male and female mold components are operated to permit introduction of a quantity of molten polymeric material. The mold components are thereafter closed to compress the polymeric material, and form a molded closure. Subsequent separation of the mold components permits the closure to be removed, and the cycle repeated. Alternatively, injection molding technology can be employed for efficient closure manufacture, wherein, single-cavity or multi-cavity injection molds are first closed, and molten plastic material injected therein for closure formation. Molded closures are removed by operating the molds to open the cavities, and the molding cycle repeated.

Current technology for manufacture of closures in this fashion typically requires that a lubricating material, such as an erucamide lubricant, be compounded into the polymeric resin, thus facilitating ejection of the molded closure from the tooling components, as well as achieving certain performance characteristics of the closure during application and removal from an associated container. Because the lubricant composition must migrate to the surface of the molded closure in sufficient quantity to perform the intended functions, the lubricant must sometimes be included in the polymeric material at relatively high percentages The inclusion of such relatively high percentages of the lubricant composition can undesirably increase the closure costs.

The present invention contemplates enhancing the distribution of a lubricant composition on a molded plastic closure, such that the composition is applied to an inside surface of the closure, in appropriate concentrations, so as to permit efficient closure manufacture, and to achieve the requisite closure performance characteristics.

### SUMMARY OF THE INVENTION

A molded plastic closure formed in accordance with the present invention includes a closure cap having a top wall portion, and an annular skirt portion depending from the top wall portion. The skirt portion includes at least one retention element, such as a helical thread, for removably retaining the closure on an associated container.

The closure includes a lubricant composition, which in accordance with the present invention, is provided at a relatively greater concentration at an inside surface of the closure, than at an outside surface thereof. Thus, those portions of the closure which contact the associated container are provided with the necessary lubricant in order to achieve the desired performance characteristics relating to high-speed closure application, and closure removal by consumers.

It is within the purview of the present invention that the lubricant be non-uniformly distributed on the inside surface of the closure, so that a relatively higher concentration of the lubricant composition is provided, on average, on those portions of the inside surface that contact the associated container. Application of two different types of lubricant compositions to two different regions of the inside surface of the closure can also be effected.

Other features and advantages of the present invention will become readily apparent from the following detailed description, the accompanying drawings, and the appended claims.

### BRIEF DESCRIPTION OF THE DRAWINGS

FIG. 1 is a perspective view of a molded plastic closure having a lubricant composition applied to a region of the inside surface thereof, in accordance with the present invention; and

FIG. 2 is another perspective view of a molded plastic closure in accordance with the present invention, having two different types of lubricant compositions applied to two different regions of the inside surface thereof.

### DETAILED DESCRIPTION

While the present invention is susceptible of embodiment in various forms, there is shown in the drawings and will herein after be described the presently preferred embodiments, with the understanding that the present disclosure is to be considered as an exemplification of the invention, and is not intended to limit the invention to the specific embodiments disclosed herein.

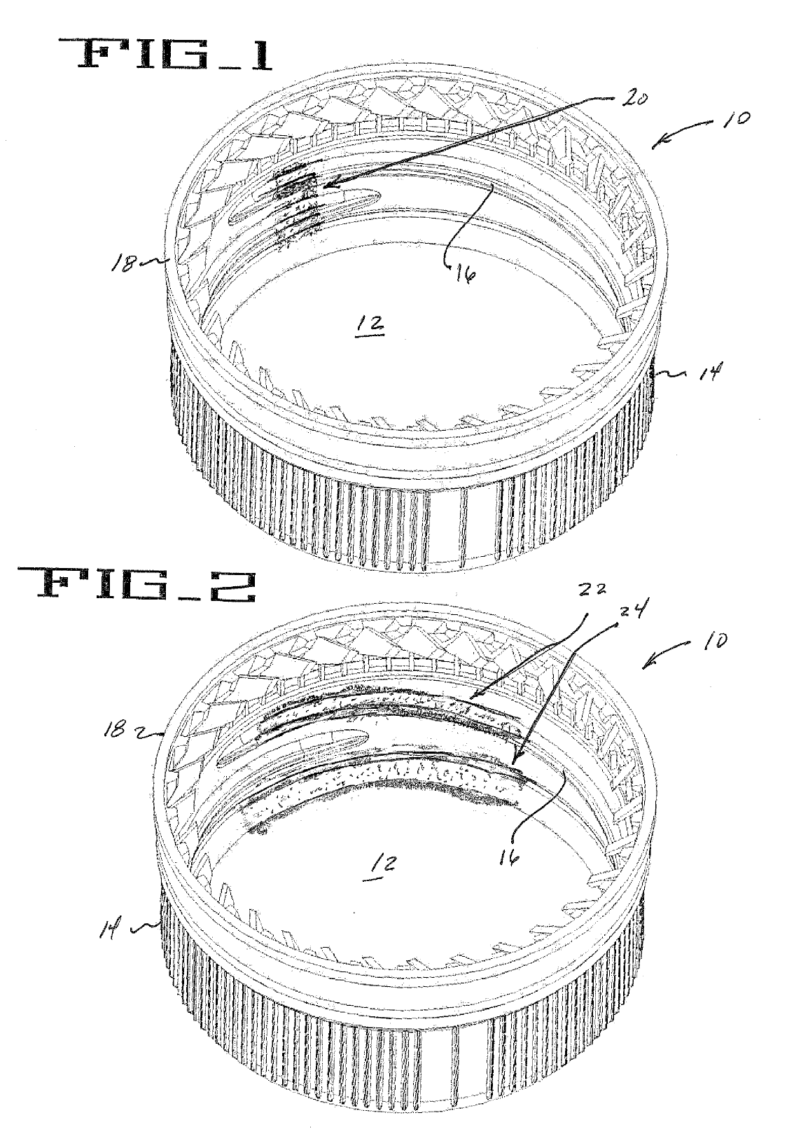

With reference to FIGS. 1 and 2, therein is illustrated a molded plastic closure 10 embodying the principles of the present invention. While the specific configuration of the closure 10 can be varied while keeping with the principles disclosed herein, FIGS. 1 and 2 illustrate a typical configuration, wherein the molded closure 10 includes a molded closure cap including a top wall portion 12, and an annular, depending skirt portion 14. The closure may optionally be provided with a sealing liner positioned adjacent to the inside surface of top wall portion 12 for sealing engagement with an associated container to which the closure is applied.

In order to provide removable retention of the closure 10 on an associated container, at least one retention element, such as comprising helical thread formation 16, is provided on the inside surface of skirt portion 14 of the closure 10. The thread formation cooperates with a like thread formation of an associated container to permit removable application of the closure to the container. In the illustrated embodiment, closure 10 includes an annular, tamper-indicating pilfer band 18, at least partially detachably connected to the skirt portion 14. The pilfer band interacts with the exterior surface of the associated container, so that attendant to partial or complete removal of the closure from the container, the pilfer band 18 partially or completely separates from the skirt portion 14 to provide visually discernable evidence of opening.

In accordance with the present invention, a method of making a molded closure comprises the steps of providing a mold assembly including a male mold, and a female mold, that together cooperate to define a mold cavity. The present method further includes providing a quantity of molten polymeric material.

Closure formation by compression molding is effected by separating the male mold and the female mold to open the mold cavity, and depositing a quantity of the polymeric material into the female mold. Thereafter, the male mold and female mold are relatively moved to close the mold assembly, and to compress the quantity of polymeric material to form a molded closure. Closure formation by injection molding is effected by first closing the mold cavity, and thereafter injecting molten polymeric material into the cavity.

Closure removal is effected by separating the male mold and the female mold to open the mold cavity, and removing the molded closure therefrom. In accordance with the present invention, a lubricant composition is applied on an inside surface of the molded closure, thereby providing the desired relatively higher concentration of the lubricant composition on an inside surface of the closure than on an outside surface thereof.

The present method can be practiced by applying the lubricant composition to the inside surface of the closure after removal of the closure from the mold assembly, such as by spray application. In an alternate embodiment, the step of applying a lubricant composition includes applying the lubricant composition to the male mold, such as by spraying. Alternatively, the lubricant composition on the inside surface of the molded closure can include application of the lubricant composition to an associated container to which the molded closure is applied.

As will be appreciated, it is within the purview of the present invention that a lubricant composition be provided in the polymeric material from which the closure is formed, aside from that lubricant composition applied to the inside surface of the molded closure. In this aspect of the present invention, the lubricant composition provided in the polymeric material can be a different composition than the one applied to the inside surface of the molded closure.

The lubricant composition provided on the inside surface of the molded closure can be provided by application of the composition to the quantity of molten polymeric material from which the closure is formed, which molten material is introduced into the mold assembly prior to compression and molding of the closure from the polymeric material.

To facilitate application of the lubricant composition to the inside surface of the molded closure, an electrostatic charge can be applied to the lubricant composition to facilitate its application.

As noted, the lubricant composition can be non-uniformly applied to the inside surface of the molded closure, to thereby provide, on average, a relatively higher level of lubricant concentration on those portions of the inside surface that contact the associated container, typically at one or more regions of relatively high interference of the closure with the associated container.

FIGS. 1 and 2 illustrate embodiments of the present invention, wherein a lubricant composition has been applied to one or more selected regions of the inside surface of the closure 10. These embodiments illustrate interior surface heterogeneity of the lubricant composition, that is, while lubricant may be present on other portions of both the interior and exterior surfaces of the closure, the concentration of lubricant composition has intentionally been increased in particular regions of the inside surface of the closure. These regions are those which exhibit high container finish/closure interference, which regions generate application and removal torque. Ideally, it is desirable to avoid or minimize lubrication on those regions which have no effect on the application or removal of the closure, where the lubricant composition might otherwise undesirably contaminate the contents of the associated container if it delaminates.

FIGS. 1 and 2 illustrate two different heterogeneous applications of a lubricant composition. In the embodiment of FIG. 1, the lubricant composition has been applied at a selected region of the inside surface of the closure 10, indicated at 20, which region is generally perpendicular to the retention element, i.e. thread formation 16, of the closure 10. In distinction, the embodiment of FIG. 2 includes two different lubricant compositions applied at two different selected regions of the inside surface of the closure 10, respectively designated 22 and 24. In this embodiment, the lubricant compositions have been applied generally circumferentially of the closure 10. It is contemplated that such circumferential or annular application of the lubricant composition can be effected less than 360° about the inside surface of the closure, such as 180°, or less.

The use of two different types of lubricant compositions can provide desirable “fine tuning” of the lubricant performance. By way of example, a lubricant composition exhibiting less desirable coefficient of friction reduction properties, but superior organoleptic properties, can be used at a region of the inside surface of the closure that provides an interface between the molded closure and the contents of the associated container, such as at region 24 in the embodiment of FIG. 2, generally at the sealing portion of the closure. In distinction, a lubricant composition having preferred coefficient of friction reduction properties, but less preferred organoleptic characteristics, can be applied to a region of the inside surface of the closure away from the package contents/closure interface, such as at region 22.

Thus, a lubricant composition having preferred organoleptic properties, such as behenamide, can be applied at a region that provides an interface between the molded closure and the contents of the associated container, while another, different lubricant composition having preferred lubrication properties, but less preferred organoleptic characteristics, such as erucamide, can be applied to a region of the inside surface of the closure away from the interface. By selective application of two different lubricants in this fashion, the desired closure application and removal performance characteristics can be obtained, while reducing the possibility of undesirable sensory effects from the lubricant compositions.

A package embodying the principals of the present invention comprises a molded plastic closure, such as 10, having a top wall portion 12, and an annular skirt portion 14 depending form the top wall portion, with the skirt portion 14 including at least one retention element 16 for removably retaining the closure on the associated container. The package further includes the container to which the plastic closure is removably applied, with the closure including a lubricant composition, wherein a relatively greater concentration of the lubricant composition is provided at an inside surface of the closure than at an outside surface thereof. The lubricant composition at the inside surface can be non-uniformally distributed, so that a relatively higher concentration of the lubricant composition is provided on those portions of the inside surface that contact the associated container. It is within the purview of the present invention that the lubricant composition be provided at the inside surface of the closure by application of the lubricant composition to the container prior to application of the closure thereto.

Thus, in accordance with the present invention, the necessary lubricant composition is supplied by applying a quantity of the lubricant directly onto the closure surfaces that contact the bottle when packaged. The amount of lubricant put directly into the closure shell polymer or resin can be greatly reduced as the total amount of lubricant being used.

A surface coating of the lubricant can be applied by several process methods, and results in a coating of the lubricant on the inside surfaces of the closure. Testing has shown that the efficiency of lubricant used, as related to controlling removal torque, can be substantially increased using the present method, when compared to the surface lubricant that is achieved via migration from the bulk polymer composition. By applying the coating of lubricant directly to the surfaces that require it, the quantities of lubricant now added to the closure shell can be greatly reduced, or even eliminated.

By way of example, test closures were manufactured to conduct a 24-hour cold removal torque test on three sets of closures. One set of closures was provided with a 0.9% erucamide lubricant in the shell polymer resin. A second set of closures was provided with a 0.36% erucamide lubricant in the closure polymer resin. A third set was provided with 0.36% erucamide in the polymer resin, and was provided with a surface coating of erucamide sprayed into solution onto the inside surfaces in an amount representing approximately 0.11%, by weight.

All closures were applied to associated containers using standard capping parameters. Notably, the third set of closures exhibited significantly lower removal torque than the first two sets. It was evident from the testing and the data collected that the caps had been applied sufficiently for all three sets of caps.

Subsequent testing was performed with a larger sampling, and lubricant levels were varied from 0.0% to 0.85%, and a high density polyethylene (HDPE) was added to the polymer resin in low concentrations, for a few of the closure samples. Closures from the various test conditions were divided into two groups: those that were sprayed with a surface coating of erucamide, and those that received no further treatment. In virtually all cases, the groups of caps that were sprayed produced significantly lower removal torques than those that were not sprayed. This pattern repeated over a variety of packaging conditions that were performed. It was clear from the test that the amount of lubricant composition applied to the closure's surface should be decreased to avoid having the lubricant on the container surfaces, or in the associated beverage after packaging.

Typically, in current production, a polymer composition including 0.5% to 0.9% lubricant in the polymer resin is employed. It is presently believed that a percentage on the order of greater than 0.0% to 0.2% is required to facilitate removal of closures from associated tooling. However, it has been found that a level as low as 0.2% in lubricant composition, by weight, in the polymer resin does not provide acceptable removal torques for closures molded from such resin. It appears that a surface concentration of lubricant on the order of 0.02% to 1.0% is necessary to achieve acceptable removal torques.

Thus, the present invention contemplates the formation of plastic closures with a relatively higher concentration of a lubricant composition at an inside surface of each of the molded closures. The lubricant composition can be applied by a sprayed application, or the like. It is within the purview of the present invention that the lubricant composition be non-uniformly applied to the inside surface of the closure. Additionally, it is within the purview of the present invention that differing lubricant compositions be provided, such as one composition provided in the polymer composition, and a different composition applied, such as by spraying, to the inside surface of each molded closure.

From the foregoing, it will be observed that numerous modifications and variations can be effected without departing from the true spirit and scope of the novel concept of the present invention. It is to be understood that no limitation with respect to the specific embodiments illustrated herein is intended or should be inferred. The disclosure is intended to cover by the appended claims all such modifications as fall within the scope of the claims.

What is claimed is:

1. A method of making a molded closure, comprising the steps of:
providing a mold assembly including a male mold and a female mold that together cooperate to define a mold cavity;
providing a quantity of molten polymeric material;
depositing a quantity of said polymeric material into said mold cavity;
separating said male mold and said female mold to open said mold cavity, and removing said molded closure therefrom, and
applying a lubricant composition on an inside surface of said molded closure.

2. A method of making a molded closure in accordance with claim 1, wherein:
said step of applying lubricant composition includes applying the lubricant composition to said inside surface of said closure after removal of said closure from said mold assembly.

3. A method of making a molded closure in accordance with claim 1, wherein:
said step of applying lubricant composition includes applying the lubricant composition to said male mold.

4. A method of making a molded closure in accordance with claim 1, including:
providing a lubricant composition in said polymeric material.

5. A method of making a molded closure in accordance with claim 4, wherein:
said lubricant composition provided in said polymeric material is a different lubricant composition than the one applied to the inside surface of said molded closure.

6. A method of making a molded closure in accordance with claim 2, including:
applying said molded closure to an associated container,
said step of applying the lubricant composition on the inside surface of said molded closure including application of the lubricant composition to the associated container to which said molded closure is applied.

7. A method of making a molded closure in accordance with claim 1, wherein:
said step of applying the lubricant composition on the inside surface of said molded closure is effected by application of the lubricant composition to said quantity of molten polymeric material.

8. A method of making a molded closure in accordance with claim 1, including:
applying an electrostatic charge to said lubricant composition to facilitate application to the inside surface of said molded closure.

9. A method of making a molded closure in accordance with claim 1, wherein:
said step of applying the lubricant composition includes applying the lubricant composition non-uniformly to the inside surface of the molded closure.

10. A method of making a molded closure in accordance with claim 9, wherein:
said step of applying lubricant composition includes applying the lubricant composition at one or more regions of relatively high interference of said closure with and associated container.

11. A method of making a molded closure in accordance with claim 10, including:
applying said lubricant composition generally perpendicularly of a retention element of said closure.

12. A method of making a molded closure in accordance with claim 10, including:
applying said lubricant composition generally circumferentially of said closure.

13. A method of making a molded closure in accordance with claim 9, wherein:
said step of applying lubricant composition includes applying two different types of lubricant compositions to the inside surface of the molded closure.

14. A method of making a molded closure in accordance with claim 13, including:
applying a lubricant composition having preferred organoleptic properties at a region of the inside surface of the closure that provides an interface between the molded closure and the contents of an associated container, and applying a lubricant composition having preferred lubrication properties at a region of the inside surface away from said interface.

15. A method of making a molded closure in accordance with claim 1, wherein:
said closure is formed by compression molding by separating said male mold and said female mold, and depositing said quantity of polymeric material into said female mold, and thereafter relatively moving said male mold and said female mold to close said mold cavity, and to compress said quantity of polymeric material to form a molded closure.

16. A method of making a molded closure in accordance with claim 1, wherein:
said closure is formed by injection molding, including relatively moving said male mold and said female mold to close said mold cavity, and thereafter depositing said quantity of molten polymeric material in said mold cavity.

17. A molded closure for application to an associated container, comprising:
a closure cup have a top wall portion, and an annular skirt portion depending from said top wall portion, said skirt portion including at least one retention element for removably retaining said closure on the associated container,
said closure including a lubricant composition, said closure having a relatively greater concentration of the lubricant composition at an inside surface thereof than at an outside surface thereof.

18. A molded closure for application to an associated container in accordance with claim 17, wherein:
said closure includes different lubricant compositions at the respective outside and inside surfaces thereof.

19. A molded closure for application to an associated container in accordance with claim 17, wherein:
said lubricant composition at the inside surface of said closure is non-uniformly distributed, so that there is a relatively higher concentration of the lubricant composition on portions of the inside surface that contact the associated container.

20. A molded closure for application to an associated container in accordance with claim 17, wherein:
said closure includes two different lubricant compositions applied to two different regions of the inside surface of said closure.

21. A molded closure for application to an associated container in accordance with claim 20, wherein:
a lubricant composition having preferred organoleptic properties is applied at a region of the inside surface of the closure that provides an interface between the molded closure and the contents of an associated container, and another, different lubricant composition having preferred lubrication properties is applied to a region of the inside surface of the closure away from said interface.

22. A package, comprising:
a molded plastic including closure cup having a top wall portion, and an annular skirt portion depending from said top wall portion, said skirt portion including at least one retention element for removably retaining said closure on the associated container; and
a container to which said molded plastic closure is removably applied,
said closure including a lubricant composition, said closure having a relatively greater concentration of the lubricant composition at an inside surface thereof than at an outside surface thereof.

23. A package in accordance with claim 22, wherein:
said closure includes different lubricant compositions at the respective outside and inside surfaces thereof.

24. A package in accordance with claim 22, wherein:
said lubricant composition at the inside surface of said closure is non-uniformly distributed, so that there is a relatively higher concentration of the lubricant composition on portions of the inside surface that contact the associated container.

25. A package in accordance with claim 22, wherein:
said lubricant composition is provided at the inside surface of said closure by application of said lubricant composition to said container prior to application of said closure thereto.
